(19) United States
(12) Patent Application Publication
(10) Pub. No.: US 2007/0200936 A1
(43) Pub. Date: Aug. 30, 2007

(54) Apparatus, method, and program for controlling moving images

(75) Inventor: Masahiro Terada, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/710,411

(22) Filed: Feb. 26, 2007

(30) Foreign Application Priority Data
Feb. 24, 2006 (JP) 2006-047926

(51) Int. Cl. H04N 5/91; H04N 5/76

(52) U.S. Cl. 348/231.2; 386/83

(57) ABSTRACT

In order to enable playback of a moving image in a variable manner according to desired weight, a desired threshold value of weight is obtained for a moving image regarding which a distribution of the weight at each point on a time axis has been generated. A time range extraction unit extracts all time ranges as high weight ranges wherein the weight is equal to or higher than the threshold value in the distribution. A representative image generation unit generates representative images that respectively represent the moving image in all the extracted time ranges. A display control unit displays a catalog of the representative images so as to enable playback of the moving image from the time range corresponding to a desired one of the representative images through selection of the desired representative image.

### BACKGROUND OF THE INVENTION

1. Field of the Invention

The present invention relates to a moving image control apparatus and a moving image control method for controlling playback, transfer, and the like of moving images photographed by a camcorder or the like. The present invention also relates to a program for causing a computer to execute the moving image control method.

2. Description of the Related Art

Since playback of large-sized moving images takes a long time, playback of only desired parts is desired during moving image playback. For this reason, a plurality of markers representing specific points in a moving image have been added to moving image data or outside the data, for playback of the moving image from the points of the markers by skipping the moving image thereto. Especially, since a producer can intentionally add markers for specifying desired chapters in a DVD video, the DVD video can be cued up to each of the chapters. Furthermore, since the markers are often added to points of scene changes, the DVD video can be efficiently played back by cueing up the video to each of the chapters.

Meanwhile, various methods have been proposed for generating summary images as digests of moving images and for efficiently playing back moving images according to the content of the moving images, for example. Japanese Unexamined Patent Publication No. 6(1994)-165009 proposes a method of playing back a summary image of a moving image. In this method, distribution of weight in a moving image is found along a time axis according to operation at the time of photography of the moving image, and only parts wherein the weight is high are played back in priority with reference to the distribution. In Japanese Unexamined Patent Publication No. 2001-119649, a method has been proposed for playing back a moving image while skipping low-weight scenes by setting the weights of scenes according to instructions from a user. Furthermore, a method of generating a summary image has been proposed in Japanese Unexamined Patent Publication No. 2002-290954. In this method, a distribution of weights is obtained along a time axis of a moving image according to audio information or the like included therein, and a threshold value of the weight is found according to desired playback time. A summary image comprising parts of the moving image having a weight equal to or higher than the threshold value is generated to have the desired playback time.

However, the methods described in Japanese Unexamined Patent Publications No. 6(1994)-165009, 2001-119649, and 2002-290954 can play back only summary images of moving images, and the threshold value of the weight and the desired playback time need to be set in advance. Therefore, only the summary images having the parts wherein the weight is equal to or higher than the preset threshold value can be played back.

### SUMMARY OF THE INVENTION

The present invention has been conceived based on consideration of the above circumstances. An object of the present invention is therefore to enable playback of a moving image in a variable manner according to desired weight.

Another object of the present invention is to enable compression of a moving image in a variable manner according to desired weight.

A first moving image control apparatus of the present invention comprises:

threshold value acquisition means for obtaining a desired threshold value of weight for a moving image regarding which a distribution of the weight at each point on a time axis has been generated;

time range extraction means for extracting all time ranges as high weight ranges wherein the weight is equal to or higher than the threshold value in the distribution of the weight;

representative image generation means for generating representative images that respectively represent the moving image in all of the extracted time ranges; and

display control means for displaying a catalog of all the representative images so as to enable playback of the moving image from the time range corresponding to a desired one of the representative images by selection of the desired representative image.

A second moving image control apparatus of the present invention comprises:

threshold value acquisition means for obtaining a desired threshold value of weight for a moving image regarding which a distribution of the weight at each point on a time axis has been generated; and

playback control means for changing a manner of playback of the moving image between first time ranges as high weight ranges wherein the weight is equal to or higher than the threshold value in the distribution of the weight and second time ranges as low weight ranges wherein the weight is lower than the threshold value in the distribution, in the case where an instruction to playback the moving image is received.

A third moving image control apparatus of the present invention comprises:

threshold value acquisition means for obtaining a desired threshold value of weight for a moving image regarding which a distribution of the weight at each point on a time axis has been generated; and

compression control means for compressing the moving image in second time ranges as low weight ranges wherein the weight is lower than the threshold value in the distribution of the weight at a higher compression rate than first time ranges as high weight ranges wherein the weight is equal to or higher than the threshold value in the distribution, in the case where an instruction to transfer or copy the moving image is received.

In the first to third moving image control apparatuses of the present invention, the threshold value acquisition means may obtain the threshold value by accepting specification of a desired value of the weight. Alternatively, the threshold value acquisition means may obtain the threshold value by accepting specification of a desired total time of the time ranges as the high weight ranges and by calculating a desired value of the weight according to the total time with reference to the distribution of the weight.

A first moving image control method of the present invention comprises the steps of:

obtaining a desired threshold value of weight for a moving image regarding which a distribution of the weight at each point on a time axis has been generated;

extracting all time ranges as high weight ranges wherein the weight is equal to or higher than the threshold value in the distribution of the weight;

generating representative images that respectively represent the moving image in all of the extracted time ranges; and

displaying a catalog of all the representative images so as to enable playback of the moving image from the time range corresponding to a desired one of the representative images by selection of the desired representative image.

A second moving image control method of the present invention comprises the steps of:

obtaining a desired threshold value of weight for a moving image regarding which a distribution of the weight at each point on a time axis has been generated; and

changing a manner of playback of the moving image between first time ranges as high weight ranges wherein the weight is equal to or higher than the threshold value in the distribution of the weight and second time ranges as low weight ranges wherein the weight is lower than the threshold value in the distribution, in the case where an instruction to play back the moving image is received.

A third moving image control method of the present invention comprises the steps of:

obtaining a desired threshold value of weight for a moving image regarding which a distribution of the weight at each point on a time axis has been generated; and

compressing the moving image in second time ranges as low weight ranges wherein the weight is lower than the threshold value in the distribution of the weight at a higher compression rate than first time ranges as high weight ranges wherein the weight is equal to or higher than the threshold value in the distribution, in the case where an instruction to transfer or copy the moving image is received.

According to the first moving image control apparatus and the first moving image control method of the present invention, the desired threshold value of the weight is obtained for the moving image regarding which the distribution of the weight at each point on the time axis has been generated. The time ranges as the high weight ranges wherein the weight is equal to or higher than the threshold value in the distribution are all detected for generating the representative images that represent the moving image in the respective time ranges. The representative images are displayed in the form of the catalog so as to enable playback of the moving image from the time range corresponding to the desired representative image by selection of the desired representative image.

Therefore, by selecting the desired representative image from the catalog of the representative images, the moving image can be played back from the time range represented by the selected representative image. Consequently, the moving image can be played back in a variable manner depending on the weight.

According to the second moving image control apparatus and the second moving image control method of the present invention, the desired threshold value of the weight is obtained for the moving image regarding which the distribution of the weight at each point on the time axis has been generated. The manner of playback is then changed between the first time ranges as the high weight ranges wherein the weight is equal to or higher than the threshold value and the second time ranges as the low weight ranges wherein the weight is lower than the threshold value.

Therefore, when the moving image is played back, the manner of playback is different between the time ranges of high weight and the time ranges of low weight. Consequently, whether a part of the moving image being played back is of high weight or low weight can be understood. In this manner, the moving image can be played back in a variable manner depending on the weight.

According to the third moving image control apparatus and the third moving image control method of the present invention, the desired threshold value of the weight is obtained for the moving image regarding which the distribution of the weight at each point on the time axis has been generated. In the case where an instruction to transfer or copy the moving image is received, the moving image in the second time ranges as the low weight ranges wherein the weight is lower then the threshold value is compressed at a higher compression rate than the first time ranges as the high weight ranges wherein the weight in the distribution is equal to or higher than the threshold value.

Therefore, size of data for the second time ranges can be reduced by lowering the image quality thereof, since the moving image is not of high importance in the second time ranges. In this manner, the moving image can be compressed in a variable manner according to the weight.

In addition, if the threshold value is obtained by accepting the desired value, a user can easily specify the threshold value of the weight.

In the case where specification of the desired total time of the time ranges as the high weight ranges is accepted and the threshold value is obtained by calculating the desired value of the weight according to the total time with reference to the distribution of the weight, the user can specify the desired threshold value only by specifying the total time of the time ranges as the high weight ranges.

### BRIEF DESCRIPTION OF THE DRAWINGS

FIG. 1 is a block diagram showing the configuration of a moving image control apparatus of a first embodiment of the present invention;

FIG. 2 is a graph that shows a distribution of weight;

FIG. 3 is a flow chart showing procedures carried out in the first embodiment;

FIG. 4 shows a moving image playback screen in the first embodiment;

FIG. 5 explains extraction of time ranges;

FIG. 6 shows a table of extracted time ranges;

FIG. 7 shows the moving image playback screen wherein a catalog of representative images is displayed for the case where a threshold value is Th0;

FIG. 8 shows the moving image playback screen wherein the catalog of representative images is displayed for the case where the threshold value is Th1;

FIG. 9 shows the moving image playback screen wherein the catalog of representative images is displayed for the case where the threshold value is Th2;

FIG. 10 is a block diagram showing the configuration of a moving image control apparatus of a second embodiment of the present invention;

FIG. 11 is a flow chart showing procedures carried out in the second embodiment;

FIG. 12 shows a moving image playback screen in the second embodiment;

FIG. 13 is a block diagram showing the configuration of a moving image control apparatus of a third embodiment of the present invention;

FIG. 14 is a flow chart showing procedures carried out in the third embodiment;

FIG. 15 shows a moving image transfer screen in the third embodiment;

FIG. 16 explains classification of parts of the moving image in the third embodiment; and

FIG. 17 shows a moving image playback screen of another embodiment.

### DESCRIPTION OF THE PREFERRED EMBODIMENTS

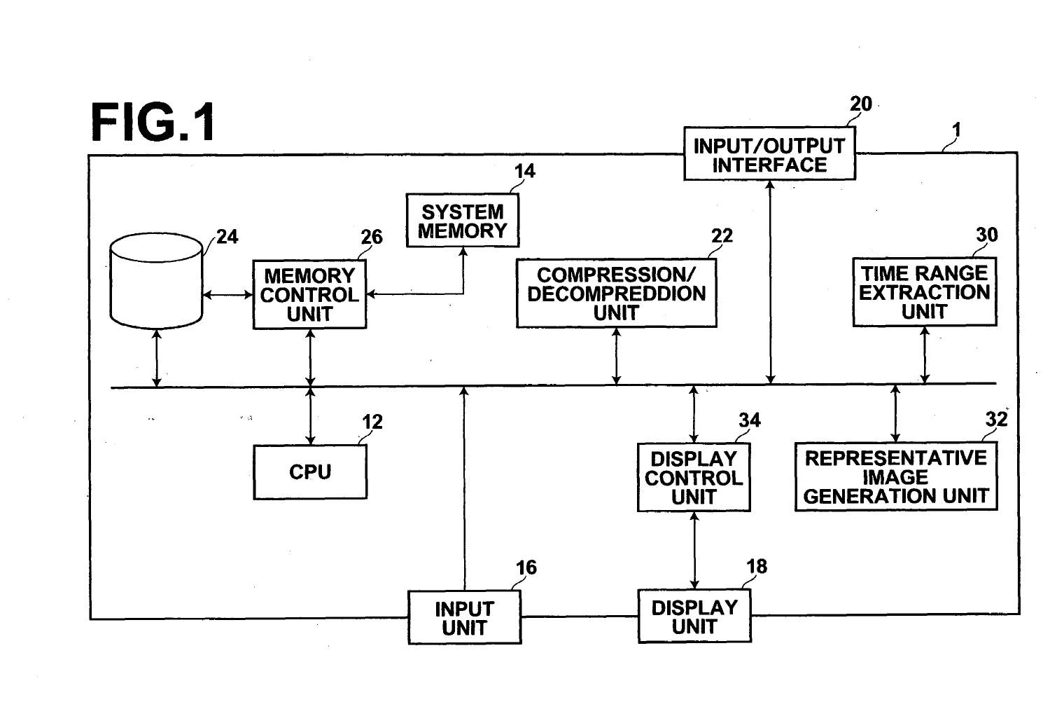

Hereinafter, embodiments of the present invention will be described with reference to the accompanying drawings. FIG. 1 is a block diagram showing the configuration of a moving image control apparatus of a first embodiment of the present invention. As shown in FIG. 1, a moving image control apparatus 1 in this embodiment comprises a CPU 12, a system memory 14, an input unit 16, and a display unit 18. The CPU 12 carries out various kinds of control such as recording control and display control of moving image data representing a moving image, and controls each of units comprising the apparatus 1. The system memory 14 comprises a ROM that stores a program for operating the CPU 12, playback software for playing back the moving image, and various kinds of constants. The system memory 14 also has a RAM used as workspace for processing by the CPU 12. The input unit 16 comprises a keyboard, a mouse, and the like for inputting various kinds of instructions to the apparatus 1. The display unit 18 has a liquid crystal monitor or the like used for various kinds of display.

The moving image control apparatus 1 also has an input/output interface 20 for inputting and outputting the moving image data representing the moving image to the apparatus 1, a compression/decompression unit 22 for compressing the moving image data according to a format such as MPEG and for decompressing compressed moving image data, a hard disc 24 for storing the moving image data and various kinds of programs executed by the CPU 12, and a memory control unit 26 for controlling the system memory 14 and the hard disc 24.

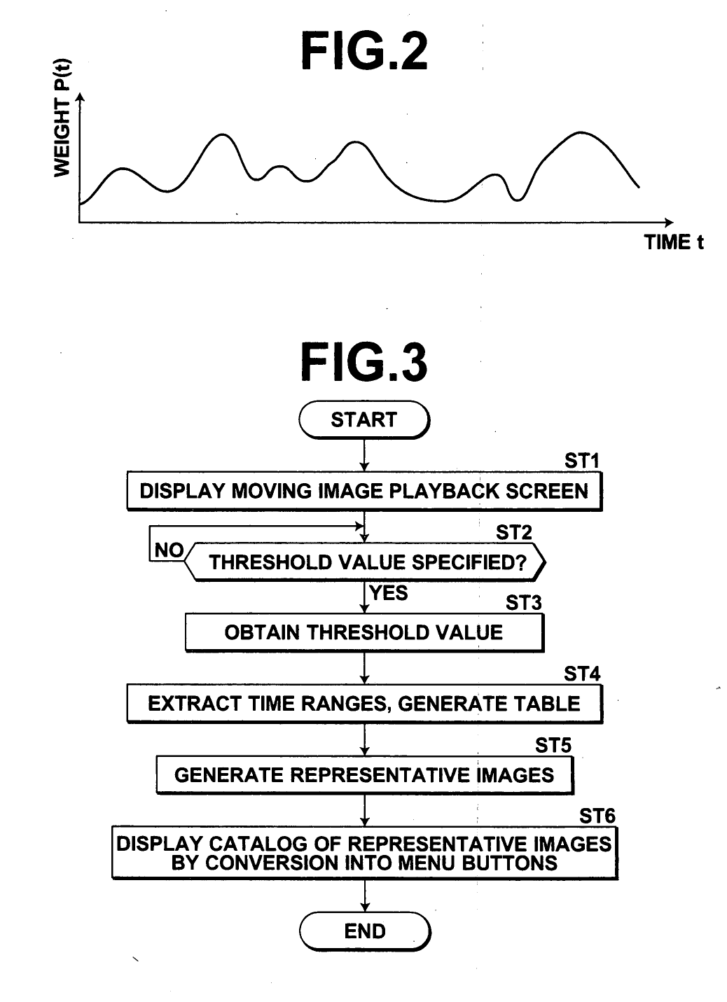

A distribution of weight at each point on a time axis has been added to the moving image input to the moving image control apparatus 1 in this embodiment. FIG. 2 is a graph that shows the distribution of the weight. As shown in FIG. 2, a distribution P(t) of the weight is obtained by plotting the weight represented by the vertical axis at a time t of the moving image represented by the horizontal axis. Audio information included in the moving image is used as the weight here. More specifically, the distribution P(t) has been generated so as to increase the weight as the volume of sound becomes larger. The weight is not necessarily limited to the audio information. For example, as has been described in Japanese Unexamined Patent Publication No. 6(1994)-165009, the weight may be weight depending on the operation at the time of photography. Alternatively, the weight may be weight set by a user viewing the moving image.

The moving image control apparatus 1 also comprises a time range extraction unit 30, a representative image generation unit 32, and a display control unit 34. The time range extraction unit 30 extracts time ranges as high weight ranges wherein the weight is a threshold value or higher in the distribution P(t), based on the threshold value obtained as will be described later. The representative image generation unit 32 generates representative images respectively representing the moving image in all of the extracted time ranges. The display control unit 34 displays a catalog of all the representative images so as to enable playback of the moving image from the time range corresponding to a desired one of the representative images through selection of the desired representative image. The display control unit 34 also controls the various kinds of display on the display unit 18.

Procedures carried out in the first embodiment will be described next. FIG. 3 is a flow chart showing the procedures carried out in the first embodiment. The moving image has been input from the input/output interface 20 and stored in the hard disc 24 together with the distribution P(t) of the weight. The CPU 12 starts processing when the user inputs an instruction to specify the weight of the moving image by using the input unit 16, and the display control unit 34 displays a moving image playback screen on the display unit 18 (Step ST1).

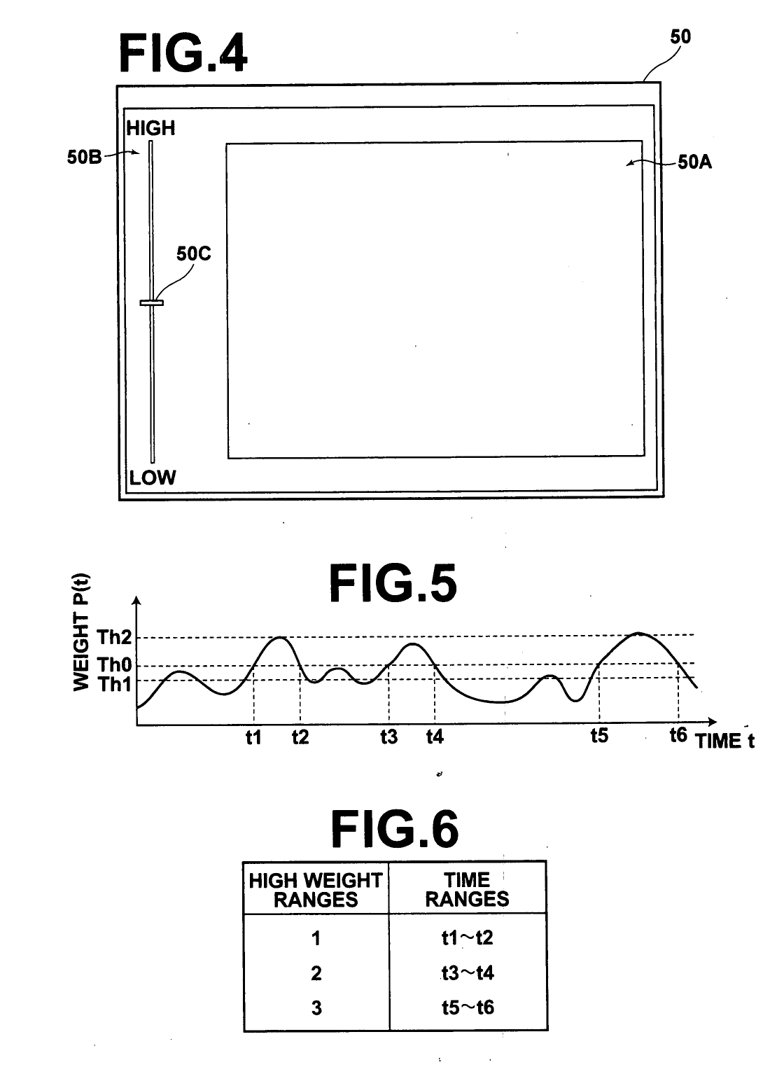

FIG. 4 shows the moving image playback screen in the first embodiment. As shown in FIG. 4, a moving image playback screen 50 has a representative image display area 50A for displaying the representative images as will be described later, and a weight bar 50B for specifying the threshold value. The user can specify the threshold value of the weight as desired, by moving up or down a scroll box 50C of the weight bar 50B by use of the input unit 16.

The CPU 12 starts monitoring on whether the threshold value has been specified through operation of the input unit 16 (Step ST2). If a result at Step ST2 is affirmative, the CPU 12 obtains the threshold value corresponding to a position of the scroll box 50C in the weight bar 50B (Step ST3). The time range extraction unit 30 then generates a table by extracting all the time ranges as the high weight ranges wherein the weight is equal to or higher than the threshold value in the distribution P(t) of the weight (Step ST4).

FIG. 5 explains extraction of the time ranges. As shown in FIG. 5, in the case where the threshold value corresponding to the position of the scroll box 50C is Th0, the time range extraction unit 30 finds all the times at which the weight is Th0 in the distribution P(t). The time range extraction unit 30 then extracts the time ranges by generating the table of the times having been found. More specifically, as shown in FIG. 5, the times at which the weight is Th0 in the distribution P(t) are t1˜t6. Therefore, the time ranges as the high weight ranges are t1˜t2, t3˜t4, and t5˜t6. The table obtained in this manner is shown in FIG. 6.

Meanwhile, in the case where the threshold value having been obtained is Th1 that is smaller than Th0, the number of the times at which the weight is Th1 in the distribution P(t) is larger than in the case of the threshold value being Th0. More specifically, the number of the times at which the weight is Th1 is 12, as shown in FIG. 5. On the contrary, in the case where the threshold value having been obtained is Th2 that is larger than Th0, the number of the times at which the weight becomes Th2 in the distribution P(t) is smaller than in the case of the threshold value being Th0. More specifically, the number of the times at which the weight becomes Th2 is 2, as shown in FIG. 5.

In FIG. 5, the number of the times having been found is an even number in all the cases. However, in the case where the weight at the ending time of the moving image is larger than the threshold value having been obtained, the number of the times at which the weight becomes the threshold value is an odd number. In this case, the ending time of the moving image is regarded as the ending time of the last time range so that the number of the times at which the weight is the threshold value becomes an even number in all cases. Likewise, in the case where the weight at the starting time of the moving image is larger than the threshold value having been obtained, the number of the times at which the weight becomes the threshold value is also an odd number. In this case, the starting time of the moving image is regarded as the starting time of the first time range so that the number of the times at which the weight is the threshold value becomes an even number in all cases.

The representative image generation unit 32 generates the representative images of all of the extracted time ranges (Step ST5). The representative images can be generated by using a first frame, a last frame, a frame in the middle, or a randomly selected frame in the moving image in each of the time ranges having been extracted, for example. However, the representative images are preferably generated from the first frame in each of the time ranges.

The display control unit 34 displays the catalog of the representative images in the representative image display area 50A in the moving image playback screen 50 by changing the representative images into menu buttons (Step ST6) to end the procedures.

Changing the representative images into menu buttons refers to displaying the representative images so as to enable playback of the moving image from the time range corresponding to the desired one of the representative images through selection of the desired representative image.

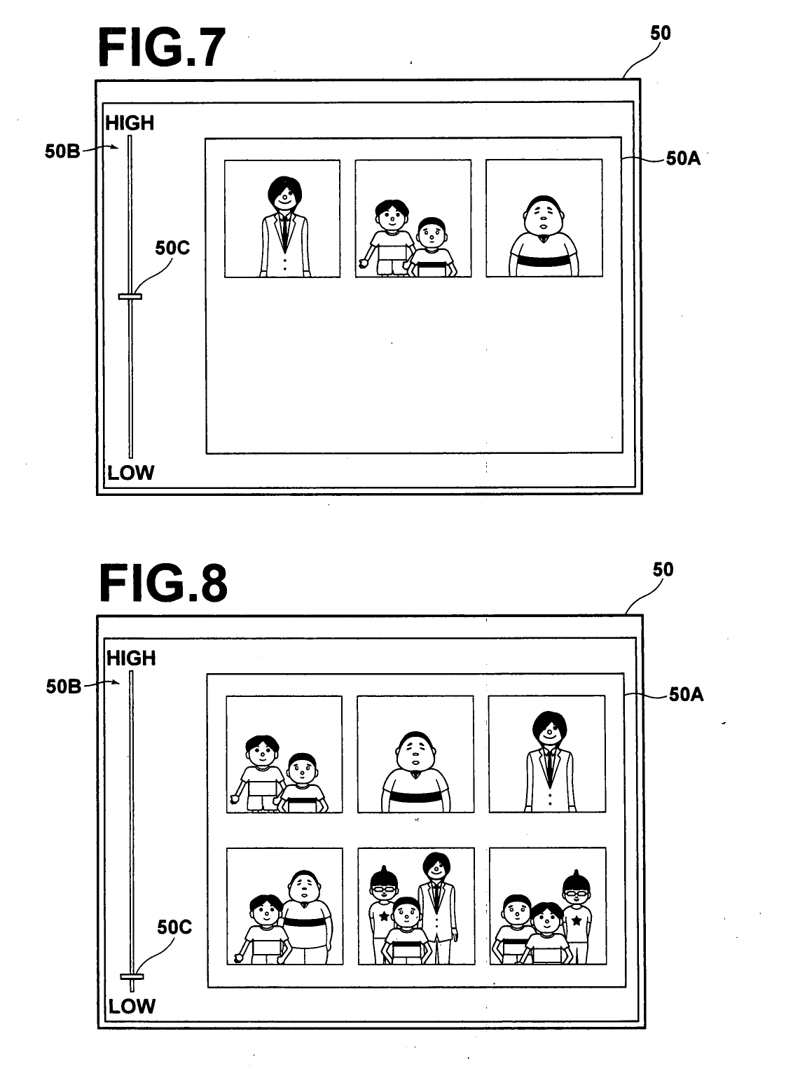

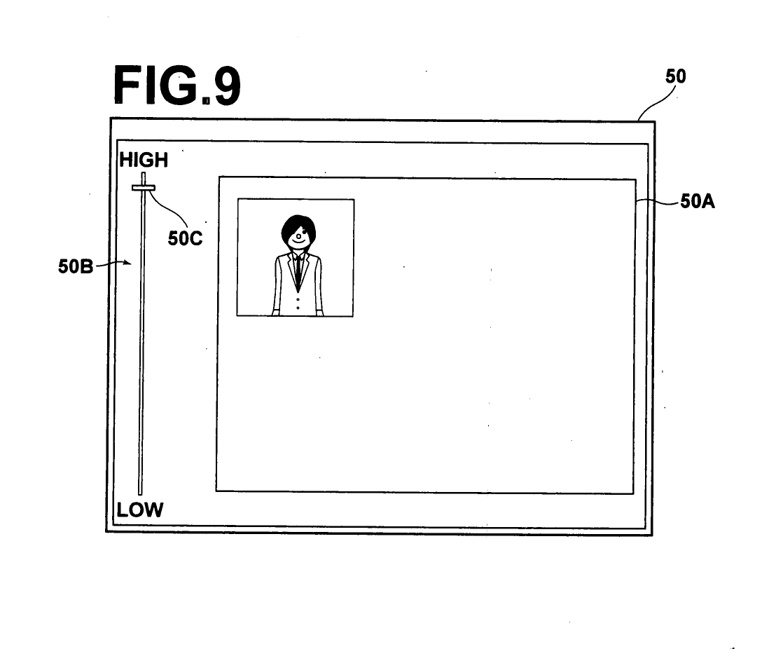

FIG. 7 shows the moving image playback screen wherein the representative images for the case of the threshold value being Th0 are displayed. As shown in FIG. 7, the number of the time ranges to be extracted is 3 for this case. Therefore, 3 representative images are shown. In the case of the threshold value being Th1, the number of the time ranges to be extracted is 6. Consequently, 6 representative images are displayed as shown in FIG. 8. In the case of the threshold value being Th2, the number of the time ranges to be extracted is 1. Therefore, 1 representative image is displayed, as shown in FIG. 9.

The user can play back the moving image from the part of the desired representative image, through selection of the representative image displayed in the screen. At this time, only the moving image in the time range corresponding to the selected representative image may be played back. The moving image may be played back in the representative image display area 50A, or in a window opened separately.

As has been described above, in the first embodiment, the time ranges as the high weight ranges having the weight equal to or higher than the obtained threshold value are extracted in the distribution P(t) of the weight, and the representative images of the moving image in the extracted time ranges are displayed by being converted into the menu buttons. Therefore, the user can play back the moving image from the time range corresponding to the desired representative image through selection of the desired representative image from the catalog of the representative images. Consequently, the user can play back the moving image in a variable manner according to the weight, by specification of the desired threshold value.

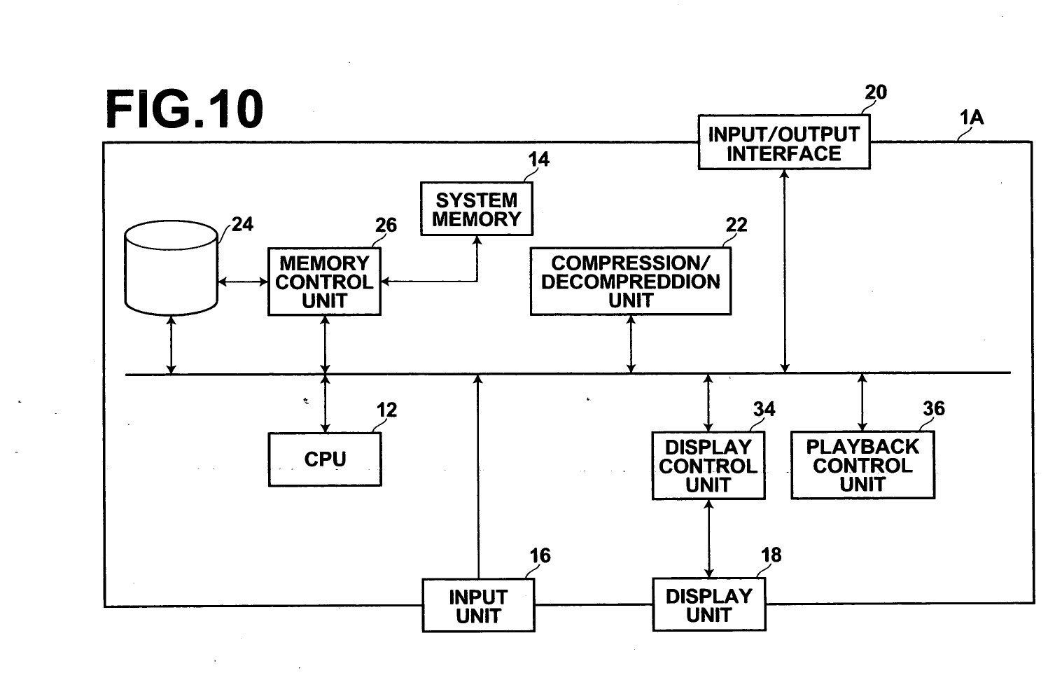

A second embodiment of the present invention will be described next. FIG. 10 is a block diagram showing the configuration of a moving image control apparatus of the second embodiment of the present invention. In the second embodiment, the same elements as in the first embodiment have the same reference codes, and detailed description thereof is omitted. A moving image control apparatus 1A in the second embodiment has a playback control unit 36 for changing a manner of moving image playback between first time ranges as high weight ranges wherein weight is equal to or higher than a threshold value in distribution P(t) and second time ranges as low weight ranges wherein the weight is smaller than the threshold value, instead of the time range extraction unit 30 and the representative image generation unit 32 in the first embodiment.

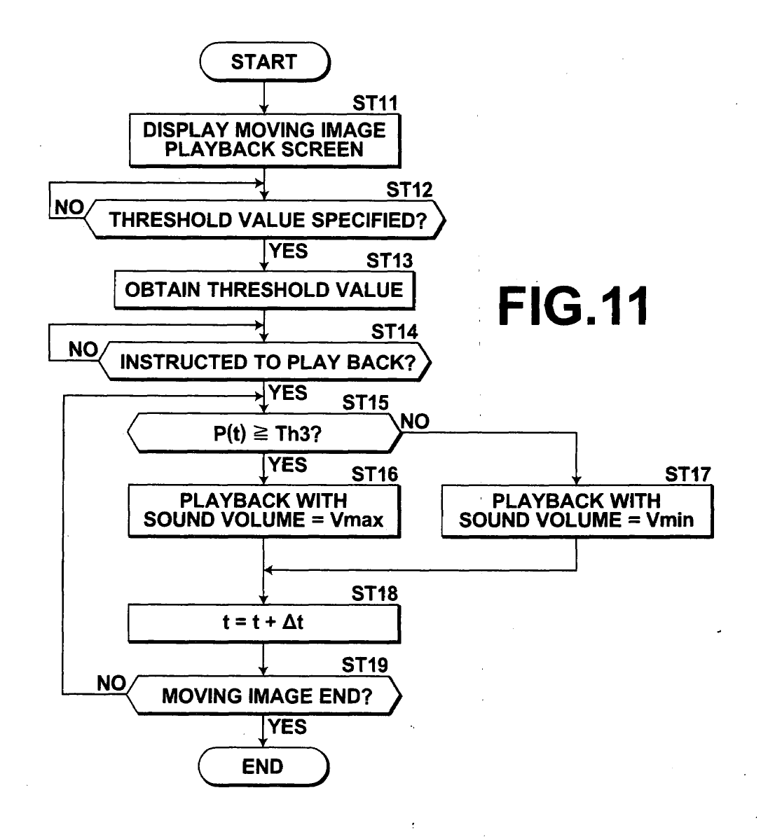

Procedures carried out in the second embodiment will be described next. FIG. 11 is a flow chart showing the procedures carried out in the second embodiment. A moving image has been input from an input/output interface 20 and stored in a hard disc 24 together with the distribution P(t) of the weight. A CPU 12 starts processing when a user inputs an instruction to specify the weight of the moving image by use of an input unit 16, and a display control unit 34 displays a moving image playback screen on a display unit 18 (Step ST11).

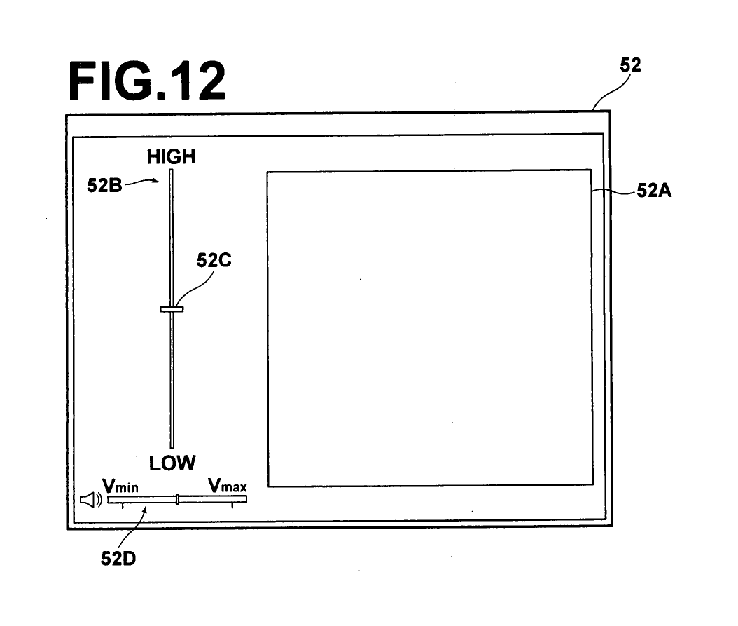

FIG. 12 shows the moving image playback screen in the second embodiment. As shown in FIG. 12, a moving image playback screen 52 has a moving image playback area 52A wherein the moving image is played back as will be described later, a weight bar 52B for specifying the threshold value, and a sound volume bar 52D for setting sound volume. The user can specify the threshold value of the weight as desired by moving up or down a scroll box 52C of the weight bar 52B with the input unit 16.

The CPU 12 then starts monitoring on whether the threshold value has been specified by operation of the input unit 16 (Step ST12). If a result at Step ST12 is affirmative, the CPU 12 obtains the threshold value corresponding to a position of the scroll box 52C in the weight bar 52B (Step ST13).

The playback control unit 36 then starts monitoring on whether an instruction to play back the moving image has been input (Step ST14). If a result at Step ST14 is affirmative, judgment is made as to whether the weight at a current playback time t of the moving image is equal to or higher than the threshold value (hereinafter referred to as Th3) having been obtained (Step ST15). If a result at Step ST15 is affirmative, the moving image is played back by setting the sound volume to be predetermined volume Vmax (Step ST16), since the corresponding time range is one of the first time ranges as the high weight ranges wherein the weight is equal to or higher than the threshold value Th3. If the result at Step ST15 is negative, the moving image is played back by setting the sound volume to be Vmin that is smaller than Vmax (Step ST17), since the time range is one of the second time ranges as the low weight ranges wherein the weight is smaller than the threshold value Th3.

The time to be played back is then set to t+Δt (Step ST18), and whether the playback of the moving image has been completed is then judged (Step ST19). If a result at Step ST19 is negative, the flow of processing returns to Step ST15, and the procedures from Step ST15 are repeated. If the result at Step ST15 is affirmative, the procedures end.

As has been described above, in the second embodiment, the manner of playback is changed between the first time ranges as the high weight ranges wherein the weight is equal to or higher than the threshold value in the distribution P(t) and the second time ranges as the low weight ranges wherein the weight is smaller than the threshold value. Therefore, the user can understand whether a part being played back in the moving image is of high weight or low weight, since the manner of playback is different between the high weight ranges and the low weight ranges. Consequently, the user can play back the moving image in a variable manner according to the weight by specifying the desired threshold value.

In the second embodiment, the sound volume of the moving image is changed between the first time ranges and the second time ranges. However, a playback speed may be changed. For example, the moving image may be played back at an ordinary speed in the first time ranges while the moving image is played back faster in the second time ranges. Alternatively, the moving image may be played back in an ordinary image size in the first time ranges while the moving image may be played back in a smaller size in the second time ranges.

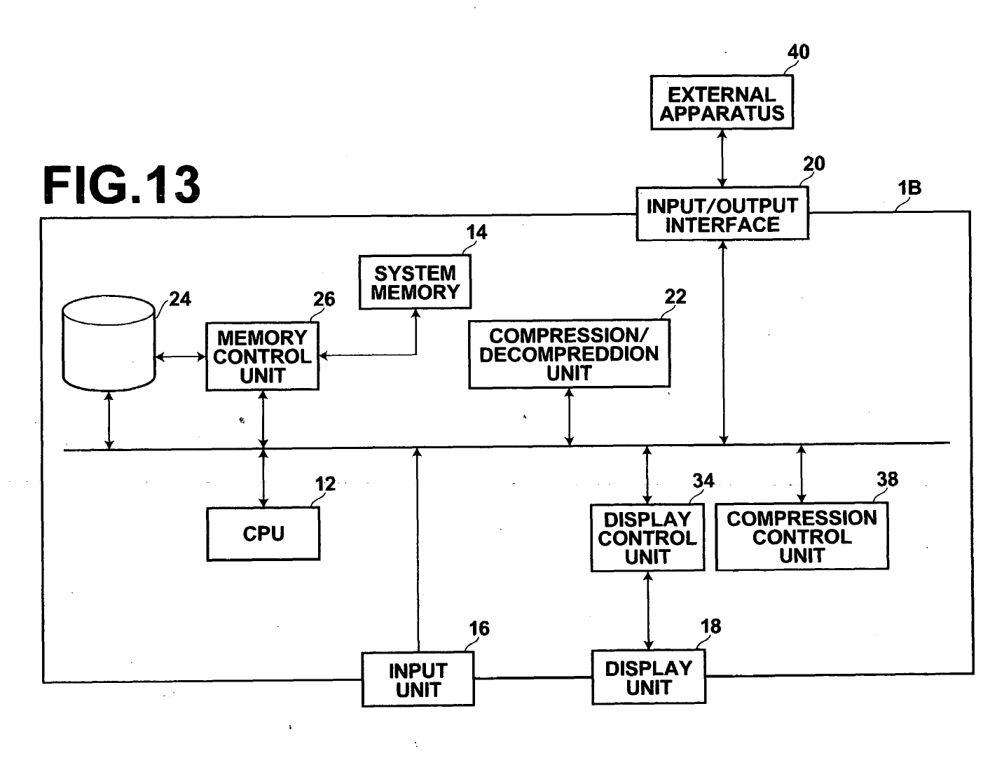

A third embodiment of the present invention will be described next. FIG. 13 is a block diagram showing the configuration of a moving image control apparatus in the third embodiment of the present invention. In the third embodiment, the same elements as in the first embodiment have the same reference codes, and detailed description thereof is omitted. A moving image control apparatus 1B in the third embodiment is different from the first embodiment in that the apparatus 1B has a compression control unit 38, instead of the time range extraction unit 30 and the representative image generation unit 32 in the first embodiment. The compression control unit 38 compresses a moving image in second time ranges as low weight ranges wherein weight is lower than a threshold value in distribution P(t) of the weight at a higher compression rate than first time ranges as high weight ranges wherein the weight is not smaller than the threshold value, when an instruction to transfer or copy the moving image is received. An external apparatus 40 is connected to an input/output interface 20 for transferring or copying the moving image stored in a hard disc 24.

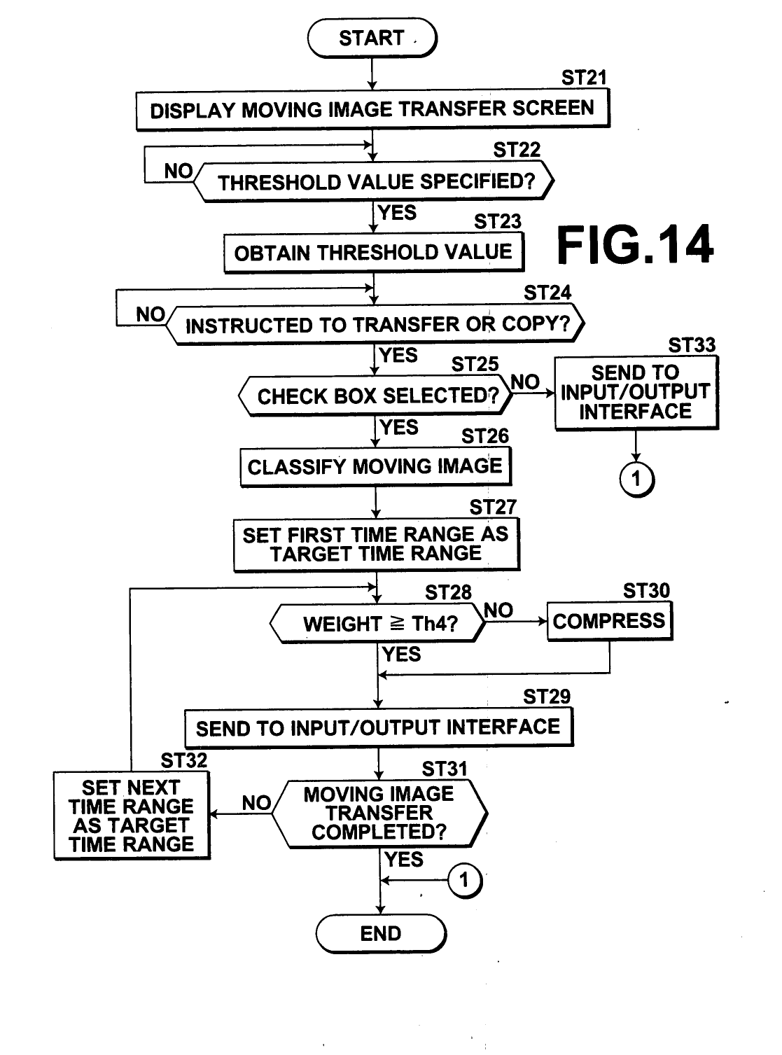

Procedures carried out in the third embodiment will be described next. FIG. 14 is a flow chart showing the procedures in the third embodiment. The moving image has been input from an external apparatus that is different from the external apparatus 40 via the input/output interface 20, and stored in the hard disc 24 together with the distribution P(t). When a user inputs an instruction to specify the weight of the moving image from an input unit 16, a CPU 12 starts processing. A display control unit 34 displays a moving image transfer screen on a display unit 18 (Step ST21).

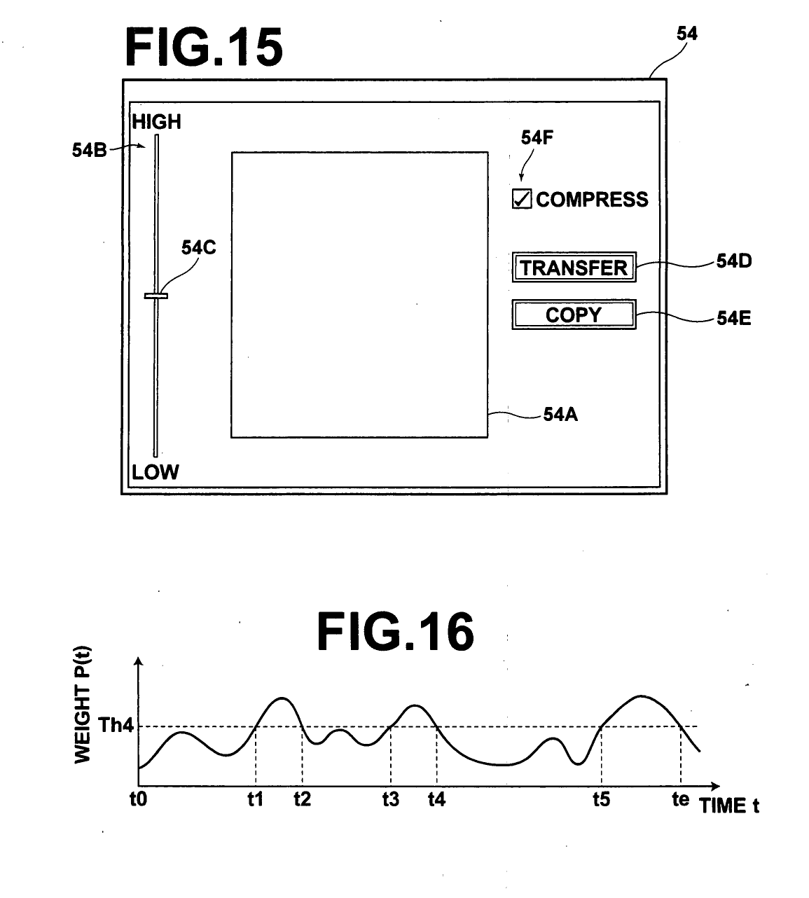

FIG. 15 shows the moving image transfer screen in the third embodiment. As shown in FIG. 15, a moving image transfer screen 54 has a representative image display area 54A wherein a representative image (such as the first frame) of the moving image is displayed, a weight bar 54B for specifying the threshold value, a scroll box 54C for specifying the weight, a Transfer button 54D for transferring the moving image to the external apparatus 40, a Copy button 54E for copying the moving image to the external apparatus 40, and a check box 54F for specifying whether the moving image is compressed at the time of transfer or copy of the moving image.

The user can specify the threshold value of the weight as desired, by moving up or down the scroll box 54C in the weight bar 54B by use of the input unit 16. The user can also specify whether to compress the moving image at the time of transfer or copy of the moving image by selecting or not selecting the check box 54F.

The CPU 12 starts monitoring on whether the threshold value of the weight has been specified through operation of the input unit 16 (Step ST22). If a result at Step St22 is affirmative, the CPU 12 obtains the threshold value corresponding to a position of the scroll box 54C in the weight bar 54B (Step ST23).

The compression control unit 38 starts monitoring on whether an instruction to transfer or copy the moving image has been input by selection of the Transfer button 54D or the Copy button 54E (Step ST24). If a result at Step ST 24 is affirmative, judgment is made as to whether the check box 54F has been selected (Step S25). The description below assumes that the Transfer button 54D has been selected.

If a result at Step ST25 is affirmative, times at which the weight is the specified threshold value are all found in the distribution P(t), and the moving image is classified into time ranges determined by the times having been found (Step ST26). For example, in the case where the threshold value is Th4 as shown in FIG. 16, times t1˜t5 at which the weight is the threshold value Th4 are found in the distribution P(t), and the moving image is classified into 6 time ranges t0˜t1, t1˜t2, t2˜t3, t3˜t4, t4˜t5, and t5˜te where t0 and te are the starting time and the ending time of the moving image. The time ranges t1˜t2, t3˜t4, and t5˜te are the high weight ranges wherein the weight is equal to or higher than the threshold value Th4 while the time ranges t0˜t1, t2˜t3, and t4˜t5 are the low weight ranges wherein the weight is smaller than the threshold value Th4.

A time range of the moving image to be transferred or copied (hereinafter referred to as a target time range) is then set to be the first time range (Step ST27), and whether the weight in the target time range is equal to or higher than the threshold value Th4 is judged (Step ST28). If a result at Step ST28 is affirmative, the moving image in the target time range is sent as it is to the input/output interface 20 (Step ST29). If the result at Step ST28 is negative, the moving image in the target time range is compressed to a predetermined bit rate (Step ST30), and sent to the input/output interface 20 (Step ST29). The moving image is transferred from the input/output interface 20 to the external apparatus 40.

Whether transfer of the moving image to the input/output interface 20 has been completed is then judged (Step ST31). If a result at Step ST31 is negative, the target time range is set to be the immediately following time range (step ST32). The flow of processing then returns to Step ST28, and the procedures from Step ST28 are repeated. If the result at Step ST31 is affirmative, the procedures end.

If the result at Step ST25 is negative, the moving image is sent to the input/output interface 20 as it is (Step ST33) to end the procedures.

As has been described above, in the third embodiment, the moving image is compressed at the higher compression rate in the second time ranges as the low weight ranges wherein the weight is lower than the threshold value than in the first time ranges as the high weight ranges wherein the weight is equal to or higher than the threshold value in the distribution P(t) of the weight, when the instruction to transfer or copy the moving image is input. Therefore, data size can be reduced for the second time ranges by degrading image quality thereof, since the moving image is not so important in the second time ranges. Consequently, the user can compress the moving image in a variable manner according to the weight, by specification of the desired threshold value.

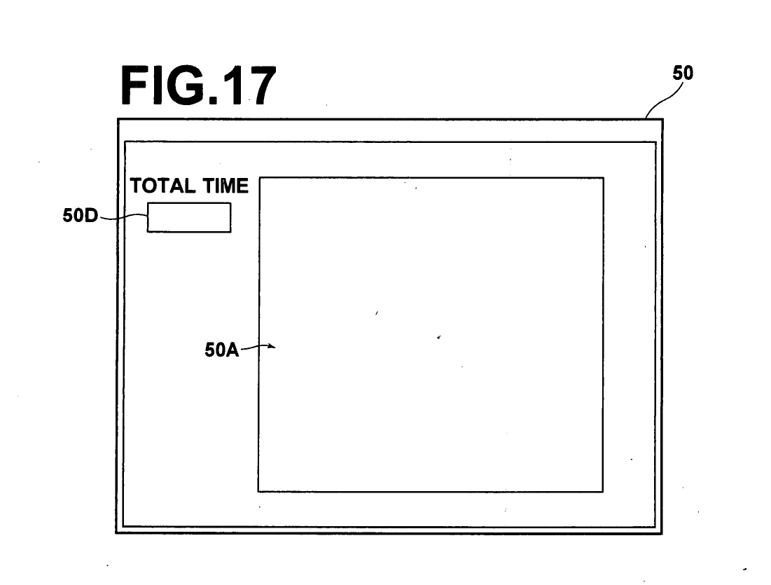

In the first to third embodiments described above, the user specifies the threshold value of the weight by use of the weight bars 50B, 52B, and 54B. However, as shown in FIG. 17, a time input box 50D may be displayed instead of the weight bar 50B in the moving image playback screen 50, for inputting a total time of the time ranges as the high weight ranges. By letting the user input the total time of the time ranges as the high weight ranges as desired, the threshold value may be calculated based on the total time, with reference to the distribution P(t) of the weight. For example, in the case where the total time having been input is 30 seconds, the threshold value causing the total time of the time ranges as the high weight ranges to become 30 seconds is found by moving the threshold value in the distribution P(t), and used as the threshold value of the weight.

Although the apparatuses related to the embodiments of the present invention have been described above, a program that causes a computer to function as means corresponding to the time range extraction unit 30, the representative image generation unit 32, the display control unit 34, the playback control unit 36, and the compression control unit 38 and to carry out the processing shown in FIGS. 3, 11, and 14 is also an embodiment of the present invention. A computer-readable recording medium that stores the program is also an embodiment of the present invention. The program may be incorporated in moving image playback software, for moving image playback.

What is claimed is:

1. A moving image control apparatus comprising:
threshold value acquisition means for obtaining a desired threshold value of weight for a moving image regarding which a distribution of the weight at each point on a time axis has been generated;
time range extraction means for extracting all time ranges as high weight ranges wherein the weight is equal to or higher than the threshold value in the distribution of the weight;
representative image generation means for generating representative images respectively representing the moving image in all of the extracted time ranges; and
display control means for displaying a catalog of all the representative images so as to enable playback of the moving image from the time range corresponding to a desired one of the representative images by selection of the desired representative image.

2. A moving image control apparatus comprising:
threshold value acquisition means for obtaining a desired threshold value of weight for a moving image regarding which a distribution of the weight at each point on a time axis has been generated; and
playback control means for changing a manner of playback of the moving image between first time ranges as high weight ranges wherein the weight is equal to or higher than the threshold value in the distribution of the weight and second time ranges as low weight ranges wherein the weight is lower than the threshold value in the distribution, in the case where an instruction to playback the moving image is received.

3. A moving image control apparatus comprising:
threshold value acquisition means for obtaining a desired threshold value of weight for a moving image regarding which a distribution of the weight at each point on a time axis has been generated; and
compression control means for compressing the moving image in second time ranges as low weight ranges wherein the weight is lower than the threshold value in the distribution of the weight at a higher compression rate than first time ranges as high weight ranges wherein the weight is equal to or higher than the threshold value in the distribution, in the case where an instruction to transfer or copy the moving image is received.

4. The moving image control apparatus according to claim 1, wherein the threshold value acquisition means obtains the threshold value by accepting specification of a desired value of the weight.

5. The moving image control apparatus according to claim 2, wherein the threshold value acquisition means obtains the threshold value by accepting specification of a desired value of the weight.

6. The moving image control apparatus according to claim 3, wherein the threshold value acquisition means obtains the threshold value by accepting specification of a desired value of the weight.

7. The moving image control apparatus according to claim 1, wherein the threshold value acquisition means obtains the threshold value by accepting specification of a desired total time of the time ranges as the high weight ranges and by calculating a desired value of the weight according to the total time with reference to the distribution of the weight.

8. The moving image control apparatus according to claim 2, wherein the threshold value acquisition means obtains the threshold value by accepting specification of a desired total time of the time ranges as the high weight ranges and by calculating a desired value of the weight according to the total time with reference to the distribution of the weight.

9. The moving image control apparatus according to claim 3, wherein the threshold value acquisition means obtains the threshold value by accepting specification of a desired total time of the time ranges as the high weight ranges and by calculating a desired value of the weight according to the total time with reference to the distribution of the weight.

10. A moving image control method comprising the steps of:
obtaining a desired threshold value of weight for a moving image regarding which a distribution of the weight at each point on a time axis has been generated;
extracting all time ranges as high weight ranges wherein the weight is equal to or higher than the threshold value in the distribution of the weight;
generating representative images respectively representing the moving image in all of the extracted time ranges; and
displaying a catalog of all the representative images so as to enable playback of the moving image from the time range corresponding to a desired one of the representative images by selection of the desired representative image.

11. A moving image control method comprising the steps of:
obtaining a desired threshold value of weight for a moving image regarding which a distribution of the weight at each point on a time axis has been generated; and
changing a manner of playback of the moving image between first time ranges as high weight ranges wherein the weight is equal to or higher than the threshold value in the distribution of the weight and second time ranges as low weight ranges wherein the weight is lower than the threshold value in the distribution, in the case where an instruction to play back the moving image is received.

12. A moving image control method comprising the steps of:
obtaining a desired threshold value of weight for a moving image regarding which a distribution of the weight at each point on a time axis has been generated; and
compressing the moving image in second time ranges as low weight ranges wherein the weight is lower than the threshold value in the distribution of the weight at a higher compression rate than first time ranges as high weight ranges wherein the weight is equal to or higher than the threshold value in the distribution, in the case where an instruction to transfer or copy the moving image is received.

13. A program causing a computer to execute a moving image control method comprising the procedures of:
obtaining a desired threshold value of weight for a moving image regarding which a distribution of the weight at each point on a time axis has been generated;
extracting all time ranges as high weight ranges wherein the weight is equal to or higher than the threshold value in the distribution of the weight;
generating representative images respectively representing the moving image in all of the extracted time ranges; and
displaying a catalog of all the representative images so as to enable playback of the moving image from the time range corresponding to a desired one of the representative images by selection of the desired representative image.

14. A program causing a computer to execute a moving image control method comprising the procedures of:
obtaining a desired threshold value of weight for a moving image regarding which a distribution of the weight at each point on a time axis has been generated; and
changing a manner of playback of the moving image between first time ranges as high weight ranges wherein the weight is equal to or higher than the threshold value in the distribution of the weight and second time ranges as low weight ranges wherein the weight is lower than the threshold value in the distribution, in the case where an instruction to play back the moving image is received.

15. A program causing a computer to execute a moving image control method comprising the procedures of:
obtaining a desired threshold value of weight for a moving image regarding which a distribution of the weight at each point on a time axis has been generated; and
compressing the moving image in second time ranges as low weight ranges wherein the weight is lower than the threshold value in the distribution of the weight at a higher compression rate than first time ranges as high weight ranges wherein the weight is equal to or higher than the threshold value in the distribution, in the case where an instruction to transfer or copy the moving image is received.
